(19) United States
(12) Patent Application Publication
(10) Pub. No.: US 2019/0016479 A1
(43) Pub. Date: Jan. 17, 2019

(54) System Architecture For An Active Chassis System On A Motor Vehicle

(71) Applicant: ZF FRIEDRICHSHAFEN AG, Friedrichshafen (DE)

(72) Inventors: Andreas FÜSSL, Kressbronn am Bodensee (DE); Istvan HEGEDÜS-BITE, Eriskirch (DE); Daniel WOLF, Friedrichshafen (DE)

(21) Appl. No.: 16/068,842

(22) PCT Filed: Dec. 12, 2016
(86) PCT No.: PCT/EP2016/080643

§ 371 Date: Jul. 9, 2018

(30) Foreign Application Priority Data
Jan. 14, 2016 (DE) 10 2016 200 403.4

(51) Int. Cl. B64G 1/22; B64G 1/10; H02J 1/00

(52) U.S. Cl. CPC B64G 1/22; B64G 2001/228; H02J 1/00; B64G 1/10

(57) ABSTRACT

A system architecture for an active chassis system in a motor vehicle has a vehicle electrical system with a first subsystem and a second subsystem. The first subsystem has a first voltage level that is lower than a second voltage level of the second subsystem (14). At least one electric assembly unit for an active chassis element and at least one control device are provided. The electric assembly unit and the control device are supplied with the second voltage level. A vehicle having a system architecture of this kind is also described.

### CROSS REFERENCE TO RELATED APPLICATIONS

This is a U.S. national stage of application No. PCT/EP2016/080643, filed on Dec. 12, 2016. Priority is claimed on German Application No. DE102016200403.4, filed Jan. 14, 2016, the content of which is incorporated herein by reference.

### BACKGROUND OF THE INVENTION

### 1. Field of the Invention

The invention is directed to a system architecture for an active chassis system in a motor vehicle and to a vehicle with a corresponding system architecture.

### 2. Description of Prior Art

A vibration damper for a motor vehicle is disclosed in DE 101 20 102 A1. An electric adjusting mechanism of the damper shown herein is supplied via a vehicle electrical system, wherein externally induced movements of the vibration damper are utilized via the actuator for energy recovery, and this energy is fed back into the vehicle electrical system. On the one hand, dampers of this type must be operated at high power. On the other hand, voltage spikes can occur in the vehicle electrical system due to the energy recovery. The vehicle electrical systems typically used in vehicles are not optimally suited for an operation of this kind.

### SUMMARY OF THE INVENTION

Therefore, an object of the present invention is to provide a system architecture that makes it possible to operate a vibration damper with increased power input and power output in an optimal manner while continuing to use the conventional vehicle electrical system for vehicles.

The system architecture is suitable for an active chassis system adapted to a motor vehicle. The system architecture comprises a vehicle electrical system with a first subsystem and a second subsystem, wherein the first subsystem has a first voltage level that is lower than a second voltage level of the second subsystem. The vehicle electrical system is advantageously operated with DC voltage. The first voltage level can be 12 volts, for example, and the second subsystem advantageously has a voltage level of 48 volts. This system architecture is suitable for the operation of active chassis elements. In particular, the respective active chassis element has an electric assembly unit for electrically adjusting or influencing the active chassis element. The active chassis element can also possibly be utilized for energy recovery, and the recovered energy is advantageously fed into the first subsystem, particularly into corresponding energy storages of the first subsystem, by the second subsystem. The active chassis elements can be a stabilizer, a suspension spring, or a vibration damper, for example. They may be electrohydraulic or electromechanical, for example. The system architecture has at least one control device in addition to the electric assembly unit. The at least one electric assembly unit can be formed at the associated active chassis element or can be arranged spatially close to the latter. The electric assembly unit is advantageously integrated in the associated active chassis element. The electric assembly unit has, in particular, an electric drive or a motor controlled via the control device. The control device substantially provides for adjusting the respective active chassis element or for a group of a plurality of active chassis elements in order to adjust the chassis of the vehicle to the prevailing conditions, particularly road conditions, in an optimal manner.

The electric assembly unit and the control device are supplied with the second voltage level. Accordingly, the second subsystem is adapted to optimal operating conditions for the active chassis element, in this case especially the power input and power output. In doing so, it is possible to arrange further electronics elements at the second subsystem. This can include an electric drive for the motor vehicle, for example. By supplying the electric assembly unit and the control device at the second voltage level, it is possible to operate the active chassis element with a higher power input and a higher power output than with the first voltage level. In addition, existing architectures for vehicle electrical systems can continue to be used, and an interface need merely be formed between the first subsystem and second subsystem. Accordingly, parallel operation of previous vehicle electrical systems in the form of the first subsystem at the first voltage level together with a second subsystem at the second voltage level is possible. In particular, electric elements of the respective subsystem can communicate with one another and across subsystems and can possibly exchange data. Examples of this are control devices of the first subsystem and of the second subsystem.

In a particularly advantageous manner, the first subsystem and the second subsystem are connected to one another via a voltage converter.

This allows an energy transfer in both directions, i.e., from the first subsystem to the second subsystem and from the second subsystem to the first subsystem. On the one hand, this makes operation of the active chassis components possible. On the other hand, an energy storage of the vehicle electrical system can be replenished by recovery of energy from the active chassis components. In particular, one or more long-life energy storages which are arranged in the first subsystem and/or in the second subsystem can be replenished. This long-life battery can be, for example, a starter battery or a battery for an electric drive of the vehicle. The first subsystem and the second subsystem are advantageously galvanically decoupled from one another via the voltage converter, particularly via a DC voltage converter. This prevents voltage spikes in the first subsystem resulting from the second subsystem.

In a constructional variant, an intermediate electric energy storage which is operatively connected to the voltage converter is formed in the second subsystem.

For example, the intermediate electric energy storage, referred to hereinafter simply as intermediate energy storage, can absorb power spikes that are fed into the second subsystem through the energy recovery of the active chassis element. In so doing, a uniform energy transfer from the second subsystem to the first subsystem is possible. Further, the first subsystem is protected against voltage spikes from the second subsystem. Also, the intermediate energy storage can be filled from the first subsystem to allow an ongoing energy supply of the active chassis element. Accordingly, the intermediate energy storage can be used to operate the active chassis element, particularly the electric assembly unit thereof. The intermediate energy storage can be formed, for example, by a capacitor or a lithium-ion battery. The intermediate energy storage is connected directly or indirectly to the voltage converter, i.e., within an electric subassembly of the second subsystem.

A central control device and at least one satellite control device are preferably formed in the second subsystem. The satellite control device is associated with an electric assembly unit and, accordingly, with a respective active chassis element.

A quantity of satellite control devices provided in the system architecture corresponds to the quantity of active chassis elements. Accordingly, a satellite control device is associated in each instance with an active chassis element. The satellite control devices communicate with the central control device. The central control device coordinates the satellite control devices relative to one another such that the active chassis elements are optimally adapted to external conditions. The central control device can also communicate with other electric elements, for example, a vehicle control device which is arranged in the first subsystem and is operated at the first voltage level. The electric elements can be operated in the first subsystem or in the second subsystem and can be formed, for example, by sensors. To the extent that the electric elements are arranged in different subsystems, in particular between the central control device and the corresponding electric element, a galvanic decoupling is advantageous. This galvanic decoupling can be formed, for example, in the central control device, in the corresponding electric element or discretely. In an advantageous manner, the respective satellite control device is formed in spatial proximity to the associated active chassis element. In particular, it is arranged in or on the electric assembly unit or is integrated therein.

In a particular constructional variant, the central control device can be formed jointly with one of the satellite control devices. In this regard, it is possible that they are merely arranged spatially close to one another, for example, inside the corresponding electric assembly unit, but remain as two individual, independent control devices. On the other hand, a main satellite control device could be formed which takes over the function of the central control device and satellite control device for the corresponding active chassis element as an individual device.

In a particularly advantageous manner, exclusively satellite control devices, which are associated with the respective electric assembly unit of the corresponding active chassis element, are formed in the second subsystem as control devices.

In this decentralized arrangement and manner of functioning of the control devices, the latter can communicate with one another, in particular in order to relay sensor data of the respective active chassis element. In this regard, the central control device can be dispensed with in particular. In an advantageous manner, a respective satellite control device works with the acquired sensor data substantially independent from the other satellite control devices. The satellite control devices can likewise communicate with, in particular retrieve data from, further electric elements of the first subsystem and of the second subsystem. Each of the satellite control devices by themselves can be connected with the respective electric element. It is also possible that a satellite control device representing all of the satellite control devices is connected to the respective electric elements and distributes the corresponding data to the other satellite control devices. In addition, an individual electric element, e.g., the vehicle control device, can collect all additional information and convey it to the respective satellite control devices. The satellite control devices can be connected to one another in a star shape or in a ring shape, for example, via signal lines.

In addition, a system architecture is proposed in which each active chassis element has its own second subsystem with a respective control device and an electric assembly unit.

The control devices are advantageously formed as satellite control devices. In other words, a plurality of second subsystems with a satellite control device in each instance are formed at a respective active chassis element, and each of the second subsystems advantageously has its own voltage converter and is connected via the latter to the first subsystem. The remarks relating to the other constructional variants can be applied in a corresponding manner.

In a further constructional variant, at least one sensor which is connected to the central control device and/or to the satellite control device is connected to the active chassis element.

When using the central control device, it is advantageous, for example, when the measurement values measured by the sensors are conveyed directly to the central control device so that the central control device can ensure optimal cooperation between the satellite control devices. With the exclusive use of satellite control devices inside the second vehicle electrical system, the sensors of the respective active chassis element can communicate directly with the associated satellite control device. The satellite control devices can convey the measurement values measured by the sensors to one another in a corresponding manner via signal lines.

The central control device and/or the satellite control device are/is advantageously connected to a further electric element arranged inside the first subsystem or second subsystem.

An electric element of the type mentioned above can be, for example, a vehicle control device or individual sensors or a group of sensors such as a vehicle body motion sensor of the corresponding vehicle. The latter are operated in particular at the first voltage level. This electric element is possibly connected to the central control device or to one or more satellite control devices.

According to a preferred constructional variant, the central control device and/or the satellite control device are/is galvanically decoupled from the electric element of the first subsystem. The galvanic decoupling is possibly formed at the respective control device, in particular the central control device and/or the satellite control device.

In this way, the system architecture, which is already widely used, can be reused for the first subsystem, but all necessary information can be conveyed between the electric elements of the first subsystem and second subsystem.

The communication between the electric elements takes place via signal lines, in particular via a bus system. When communication takes place between electric elements arranged in different subsystems with different voltage levels, a galvanic decoupling is advantageously formed at one of the electric elements which are connected to one another or discretely between the latter.

General remarks concerning the individual advantageous constructional variants are applicable to all of the other advantageous configurations in a corresponding manner.

### BRIEF DESCRIPTION OF THE DRAWINGS

The system architecture according to the invention and the vehicle according to the invention will be explained by way of example in the following referring to two figures. The drawings show:

FIG. 1 is a system architecture with a central control device and with a plurality of satellite control devices; and

FIG. 2 is a system architecture with a plurality of satellite control devices.

### DETAILED DESCRIPTION OF THE PRESENTLY PREFERRED EMBODIMENTS

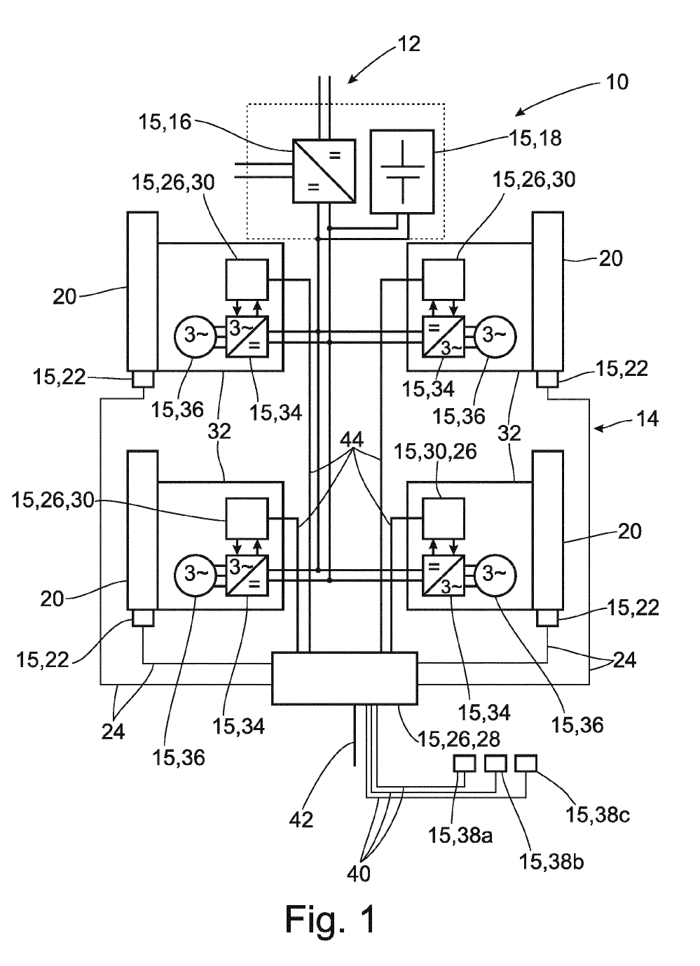

FIG. 1 shows a vehicle electrical system 10. This vehicle electrical system 10 includes a first subsystem 12 and a second subsystem 14 with corresponding electronics elements 15. The electric subsystem 12 is not shown or described in detail because it can be constructed in accordance with already known vehicle electrical systems 10 with corresponding electronics elements thereof.

The first subsystem 12 and the second subsystem 14 are connected to one another via a voltage converter 16. This voltage converter 16, which is formed as a DC converter 16, transforms a voltage or voltage level of the first subsystem 12, which is 12 volts in particular, into a second voltage level of the second subsystem 14 which, in this case, is 48 volts in particular. The first voltage level of the first subsystem 12 is accordingly lower than or less than the second voltage level of the second subsystem 14. Further, an intermediate energy storage 18 is arranged at, and is operatively connected to, the voltage converter 16. The intermediate energy storage 18 is directly connected to the voltage converter 16. The intermediate energy storage 18 is constructed in this instance as a lithium-ion battery or as a capacitor, for example. The energy storage 16 can supply the electronics elements 15 of the second subsystem 14 with energy and absorb energy generated by the electronics elements 15 of the second subsystem 14 in order to prevent an overloading of the first subsystem 12.

FIG. 1 further shows a plurality of active chassis elements 20 which, in this instance, are in the form of vibration dampers 20. A sensor 22 is arranged at the vibration damper 20 in each instance. This sensor 22 can detect a deflection state of the vibration damper 20, for example. The values measured by the sensors 22 are conveyed to a control device 26, in this instance a central control device 28, or possibly to a satellite control device 30 via signal lines 24. The central control device 28 communicates with the control devices 26 of the vibration dampers 20 which are formed as satellite control devices 30. The satellite control devices 30 are formed at or in an electric assembly unit 32 of the respective vibration damper 20. This electric assembly unit 32 and, in particular, also the satellite control device 28 is arranged in spatial proximity to, or directly at, the vibration damper 20. The electric assembly unit 32 comprises a plurality of electronics elements 15, in particular the satellite control device 28, a voltage converter 34 and a motor 36 for adjusting the vibration damper. The electric motor 36 is constructed as a three-phase motor and is supplied by the voltage converter 34 arranged inside the second subsystem 14 and operated at the second voltage level. The voltage converter 34 is controlled via the satellite control device 30 that determines and specifies the adjustment of the vibration damper 20. The data determined by the sensor 22 can be transmitted to the central control device 30 and/or to the central control device.

Further, additional electronics elements 38 of the first subsystem 12 are formed at the vehicle electrical system 10. In this regard, electric element 38a can be a vehicle control device 38a. Further sensors 38b and 38c which are operated at the first voltage level are provided with electric elements 38b and 38c, for example, in the vehicle electrical system 10. In particular, this can be a vehicle body acceleration sensor. The vehicle control device 38a is also operated at the first voltage level. In so doing, the electric elements 38 are galvanically decoupled from the control device 26 and the main control device 28. This decoupling can be formed, for example, inside of the central control device 28. This can prevent transmission of voltage spikes. This makes it possible to communicate with the electric elements 38 of the first subsystem 12 via signal lines 40. The galvanic decoupling can be carried out between the central control device 28 and the respective electric element 38 or even at the respective electric element 38.

The central control device 28 is further connected to a wake-up/switch-off line 42. In this way, the central control device and the associated satellite control devices are woken up or switched off by the vehicle control device. A life-hold signal can be generated by the respective control device 26. The life-hold signal keeps the respective control device operating until it completely writes the error memory, for example, and has possibly completely transmitted corresponding data, for example, the error memory, to another control device, particularly central control device 30 or vehicle control device 38a. The control devices 26 can likewise be switched off individually one after the other or also collectively by the life-hold signal which can be generated by the central control device 30, for example.

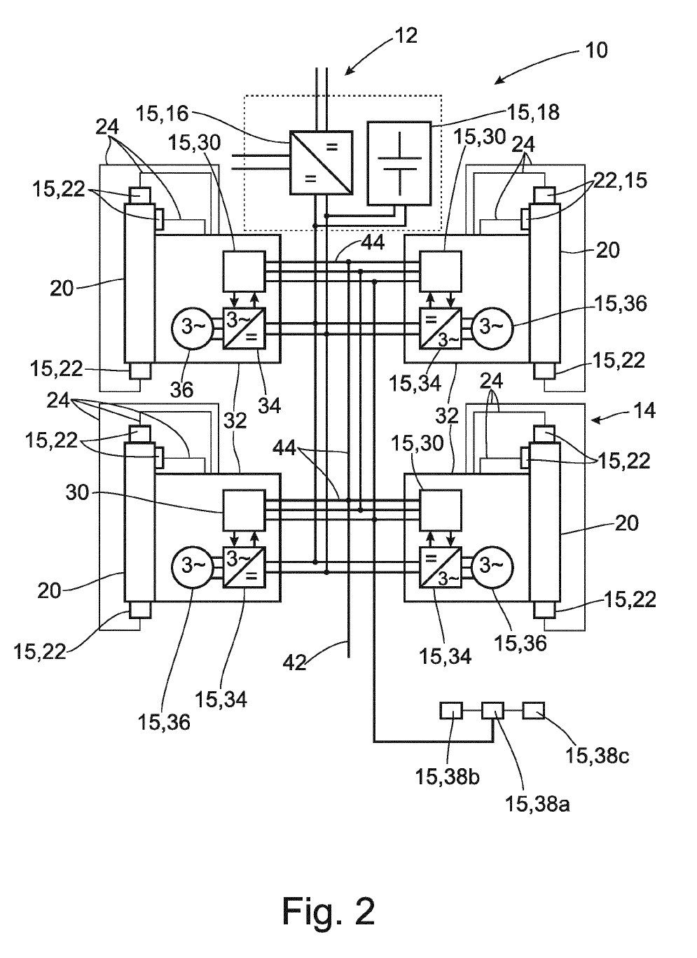

FIG. 2 shows a further vehicle electrical system 10. Substantially, the ways in which it differs from the previous constructional variants will be addressed. The reference numerals for identical or identically functioning components have been adopted from the previous constructions.

The vehicle electrical system 10 and second subsystem 14 have only satellite control devices 30 as control devices 26. These satellite control devices 26 are in a star connection with one another via communications lines 44. Alternatively, the satellite control devices 26 can also be connected to one another in a ring-shaped manner. In case of the star-shaped arrangement, each of the satellite control devices 30 is directly connected to each of the other satellite control devices 30 such that they can communicate with one another directly, for example, via a bus system, and in particular can receive or request the sensor data of the other respective satellite control devices 30. When using the ring-shaped topology, the data are routed from one satellite control device 30 to the next.

Further, each vibration damper 20 has a plurality of sensors 22 that can measure still further states of the vibration damper 20. These states are transmitted via the corresponding signal lines 24 to the satellite control device 30 associated with the respective vibration damper 20. A plurality of sensors 22 for an active chassis element 20 can also be used in the embodiment example in FIG. 1.

It is also possible that the vehicle control device 38a is connected to the satellite control devices 30. Sensor information, particularly of electric elements 38b and 38c, can be transmitted by the vehicle control device 38a to the satellite control devices 30, or data can be received by the satellite control devices 30, for example, error memory or sensor data of sensors 22. In addition, adjustments which are undertaken, for example, by the driver of the motor vehicle can be stored or processed in the vehicle control element 38a and can be transmitted to the satellite control devices 30 if necessary. In this regard, the satellite control devices 30 and the electric assembly units thereof form a common second subsystem 16. The wake-up/switch-off line 42 is connected to the individual satellite control devices 30 directly via a bus system.

In a further constructional variant in FIG. 2, each of the active chassis elements 20 can have its own second subsystem 14, for example. In this case, an electric assembly unit comprising a voltage converter, an energy storage, a control device, a motor and possibly a voltage converter associated with the motor is advantageously provided at each vibration damper 20. In so doing, each active chassis element 20 along with the associated electric assembly units forms an independent system which can be operated with a conventional vehicle electrical system. The transmission of sensor information can take place, for example, centrally via the vehicle control device 38 in one of the above-described constructional variants, or sensor information can also be transmitted directly between satellite control devices 30. For the transmission of information between electric elements of different subsystems, corresponding electric elements are galvanically isolated from one another.

1. -10. (canceled)

11. A system architecture for an active chassis system in a motor vehicle, comprising:
a vehicle electrical system having:
a first subsystem having a first voltage level;
a second subsystem having a second voltage level, wherein the first voltage level is lower than a second voltage level;
at least one electric assembly unit that is supplied with the second voltage level for an active chassis element; and
at least one control device supplied with the second voltage level.

12. The system architecture according to claim 11, further comprising:
a voltage converter that connects the first subsystem to the second subsystem.

13. The system architecture according to claim 12, further comprising:
an intermediate electric energy storage, which is operatively connected to the voltage converter, is formed in the second subsystem.

14. The system architecture according to claim 11, further comprising:
a central control device and at least one satellite control device formed in the second subsystem,
wherein the satellite control device is associated with a respective electronics assembly unit and a respective active chassis element.

15. The system architecture according to claim 11, wherein exclusively satellite control devices, which are associated with the respective electric assembly unit of a corresponding active chassis element, are formed in the second subsystem as control devices.

16. The system architecture according to claim 11, wherein each active chassis element has its own second subsystem with a respective control device and a respective electric assembly unit.

17. The system architecture according to claim 14, further comprising:
at least one sensor is connected to the active chassis element and at least one of the central control device and the satellite control device.

18. The system architecture according to claim 14, further comprising:
a further electric element arranged inside one of the first subsystem and the second subsystem, the further electric element connected to at least one of the central control device and the satellite control device.

19. The system architecture according to claim 18, wherein at least one of the central control device and the satellite control device is galvanically decoupled from the electric element of the first subsystem, wherein the galvanic decoupling is formed at the control device.

20. A vehicle with a system architecture comprising:
a vehicle electrical system having:
a first subsystem having a first voltage level;
a second subsystem having a second voltage level, wherein the first voltage level is lower than a second voltage level;
at least one electric assembly unit that is supplied with the second voltage level for an active chassis element; and
at least one control device supplied with the second voltage level.
